(19) United States
(12) Patent Application Publication
(10) Pub. No.: US 2013/0334727 A1
(43) Pub. Date: Dec. 19, 2013

(54) INJECTION MOLDING METHOD AND INJECTION MOLD ASSEMBLY

(71) Applicant: PANASONIC CORPORATION, OSAKA (JP)

(72) Inventors: Hideo MINE, Nara (JP); Chikara NAKANISHI, Osaka (JP); Masakazu HIRAISHI, Kyoto (JP)

(21) Appl. No.: 13/917,290

(22) Filed: Jun. 13, 2013

(30) Foreign Application Priority Data
Jun. 18, 2012 (JP) 2012-136473

(51) Int. Cl. B29C 45/00

(52) U.S. Cl. CPC B29C 45/0003
USPC 264/139; 425/552

(57) ABSTRACT

An injection molding method in which a multilayer film including a base layer and a transfer layer stacked on the base layer is disposed in the molding space of an injection mold, the molding space containing the multiplayer film is filled with resin, and then the injection mold is opened to obtain a molded article transferred with the transfer layer peeled from the base layer, wherein after the resin is injected into the molding space, a cooling circuit near the molding space cools the multilayer film before the injection mold is opened.

The disclosure of Japanese Patent Application No.2012-136473 filed Jun. 18, 2012 including specification, drawings and claims is incorporated herein by reference in its entirety.

### FIELD OF THE INVENTION

The present invention relates to an injection molding method in which molten resin is injected into the molding space (cavity) of an injection mold to obtain a molded article while the transfer layer of a multilayer film disposed in the cavity is transferred to the surface (transfer surface) of the molded article, and relates to an injection mold assembly for performing the injection molding method.

### BACKGROUND OF THE INVENTION

In recent years, resin moldings with high-quality appearances, e.g., highly glossy, grained, and weldless moldings have been demanded. To obtain high gloss, a mirror-finished mold surface (cavity forming surface) needs to be transferred with high quality to the surface of injection molding resin. Similarly, to obtain grain, a grained mold surface needs to be transferred with high quality to the surface of injection molding resin. To achieve such high-quality transfer, when molten resin is injected into a mold cavity, a mold surface temperature generally needs to be kept at the glass transition temperature of the molten resin or higher (about 10° C. higher than the glass transition temperature) until the molten resin is fully injected. Moreover, the mold needs to be cooled immediately after the molten resin is fully injected. This molding process is a well-known process. To obtain a weldless molding, when molten resin is injected into a mold cavity, a mold surface temperature needs to be kept at a high temperature so as to delay cooling and hardening of the molten resin until the molten resin is fully injected. Therefore, the molding process for obtaining a weldless molding is a known process similar to those for obtaining high gloss and grain.

A mold surface is heated by medium systems using media such as steam, hot water, and oil. Alternatively, a mold surface may be heated by any one of a high-frequency induction system, a radiant heat system using a halogen lamp, an electric current supply system of applying a current to a conductive layer stacked with an insulating layer on a mold surface, and an electric heater system. Of these systems, the system using steam as a medium is most commonly used. Japanese Patent Laid-Open No. 11-348041 discloses a conventional mold assembly that increases a mold surface temperature with steam. Referring to FIG. 6, the conventional mold assembly disclosed in Japanese Patent Laid-Open No. 11-348041 will be described below.

As shown in FIG. 6, a mold 61 includes a typical cooling circuit 62 for cooling the mold 61. The mold 61 further includes a heating/cooling circuit 65. The heating/cooling circuit 65 is provided closer to a molding surface (cavity forming surface) 64 that is in contact with a resin molding 63 (molten resin) than the cooling circuit 62 is. The cooling circuit 62 is always fed with cooling water during a molding time; meanwhile, the heating/cooling circuit 65 is fed with steam during heating and is fed with cooling water during cooling. When a medium passing through the heating/cooling circuit 65 is switched from cooling water to steam, air purge is performed to discharge the cooling water.

Japanese Patent Laid-Open No. 2007-118213 discloses a conventional mold assembly using the electric heater system. Referring to FIG. 7, the conventional mold assembly disclosed in Japanese Patent Laid-Open No. 2007-118213 will be described below.

A mold disclosed in Japanese Patent Laid-Open No. 2007-118213 includes a mother die (not shown) and a nest. As shown in FIG. 7, the nest includes a nest front-side member 71 and a nest back-side member 72. The nest back-side member 72 includes a typical cooling circuit 73 for cooling the mold. The nest front-side member 71 in contact with a resin molding 74 (molten resin) includes a thin-tube electric heater 76 whose shape can be changed with a high degree of freedom. The thin-tube electric heater 76 is accommodated closer to a molding surface (cavity forming surface) 75 in contact with the resin molding 74 (molten resin) than the cooling circuit 73 is. Specifically, the nest front-side member 71 has a surface in contact with the nest back-side member 72 on the opposite side from the molding surface 75 and has a groove 77 on the surface in contact with the nest back-side member 72. The groove 77 is formed such that an optimum distance for heating the molding surface 75 is obtained between the deepest portion of the groove 77 and the molding surface 75 regardless of the shape of the molding surface 75. For example, even if the molding surface 75 has steps or irregularities or is a curved surface, the optimum distance is provided between the deepest portion of the groove 77 and the molding surface 75 to heat the molding surface 75. The nest back-side member 72 has a surface in contact with the nest front-side member 71 near the molding surface 75 and has a rib 78 on the surface in contact with the nest front-side member 71, the rib 78 being provided for the groove 77 of the nest front-side member 71. The rib 78 of the nest back-side member 72 is fit into the groove 77 of the nest front-side member 71. Thus, the thin-tube electric heater 76 is closed and held in the deepest portion of the groove 77.

In recent years, high-value-added engineering plastics (e.g., polyamide, polycarbonate, and polyimide) having characteristics such as high strength have been frequently used. Engineering plastics have been also used in an injection-molding synchronous foil transfer process in which molten resin is injected into the molding space (cavity) of an injection mold to obtain a molded article while the transfer layer of a multilayer film disposed in the cavity is transferred to the surface (transfer surface) of the molded article.

Engineering plastics have a higher softening temperature than injection resin used in a typical injection-molding synchronous foil transfer process. Thus, in the use of engineering plastics, molten resin injected into the cavity of a mold has a higher temperature than molten resin injected in the typical injection-molding synchronous foil transfer process. Thus, the securing of flowable injected molten resin requires a higher molding surface temperature than a molding surface temperature set in the typical injection-molding synchronous foil transfer process. Hence, the molding process for achieving high-quality transfer has been used also in the injection-molding synchronous foil transfer process. Specifically, the following process has been used: when molten resin is injected into a cavity, a molding surface temperature is kept at the glass transition temperature of the molten resin or higher (about 10° C. higher than the glass transition temperature) until the molten resin is fully injected. Moreover, the mold is cooled immediately after the molten resin is fully injected. To be specific, in the use of engineering plastics, a molten resin temperature needs to be set around 280° C. to 340° C. while a molding surface temperature needs to be set around 80° C. to 140° C. In the typical injection-molding synchronous foil transfer process, for example, ABS resin is used and a molding surface temperature of around 40° C. to 80° C. is set.

### DISCLOSURE OF THE INVENTION

In an injection-molding synchronous foil transfer process, the opening of an injection mold peels off a transfer layer from a base layer at a release layer. Thus, the transfer layer needs to be transferred to the surface (transfer surface) of a molded article while the base layer needs to be peeled off from the molded article. In the use of engineering plastics, however, the temperature of molten resin injected into the cavity of the mold is higher than that of molten resin injected in the typical injection-molding synchronous foil transfer process, and the securing of flowable injected molten resin requires a higher molding surface temperature than a molding surface temperature set in the typical injection-molding synchronous foil transfer process. Thus, the transfer layer is partially peeled off with the base layer from the molded article, so that desired designs such as colors and patterns may not be transferred onto the surface (transfer surface) of the molded article. In the use of engineering plastics, the temperature of molten resin in contact with an adhesive layer included in the transfer layer is higher than that of molten resin injected in the typical injection-molding synchronous foil transfer process, and a molding surface temperature is higher than that set in the typical injection-molding synchronous foil transfer process. Hence, disadvantageously, an adhesive constituting the adhesive layer is not hardened and thus cannot exhibit original adhesion. If the adhesive constituting the adhesive layer cannot exhibit the original adhesion, bonding strength between the surface of the molded article and the transfer layer decreases, leading to insufficient bonding strength. Moreover, the transfer layer is likely to peel off from the surface of the molded article.

The following will describe a mechanism in which one of layers constituting a transfer layer is peeled off, and then the transfer layer bonded to a molded article is partially peeled off.

FIG. 8A illustrates an example of the layer configuration of a multilayer film used in the injection-molding synchronous foil transfer process. As shown in FIG. 8A, the multilayer film includes a base film 81, a release layer 82, a hard coating layer 83, an anchor layer 84, a color layer 85, a masking layer 86, and an adhesive layer 87 that are stacked in this order. As shown in FIG. 8B, a transfer layer to be left on the surface of a resin molding in the opening of an injection mold includes the hard coating layer 83, the anchor layer 84, the color layer 85, the masking layer 86, and the adhesive layer 87. Moreover, a base layer to be peeled off from the molding in the opening of the injection mold includes the base film 81 and the release layer 82. In the typical injection-molding synchronous foil transfer process, as shown in FIG. 8B, the base layer in the opening of the injection mold peels off from the transfer layer bonded to the resin molding, at the boundary between the release layer 82 and the hard coating layer 83.

FIG. 9 is a side cross-sectional view illustrating an opened state of a conventional injection mold assembly. As shown in FIG. 9, when an injection mold including a movable mold 91 and a fixed mold 94 is opened, a multilayer film 93 is sandwiched between the movable mold 91 and a foil holding plate 92 while a molded article 95 is bonded to a cavity forming surface 94a of the fixed mold 94. As shown in FIG. 8A, the multilayer film 93 includes the base film 81, the release layer 82, the hard coating layer 83, the anchor layer 84, the color layer 85, the masking layer 86, and the adhesive layer 87 that are stacked in this order. When the injection mold is opened, as shown in FIG. 8B, a base layer 93a including the base film 81 and the release layer 82 peels off from a transfer layer 93b including the hard coating layer 83, the anchor layer 84, the color layer 85, the masking layer 86, and the adhesive layer 87, at the boundary between the release layer 82 and the hard coating layer 83. Thus, the base layer 93a is located on a cavity forming surface 91a of the movable mold 91 while the transfer layer 93b is left on the surface of the molded article 95 bonded to the cavity forming surface 94a of the fixed mold 94.

FIG. 10A is a side cross-sectional view of the molded article 95 that is obtained by performing the conventional injection-molding synchronous foil transfer process under molding conditions where the temperature of molten resin injected into the cavity of the injection mold is higher than that of molten resin injected in the typical injection-molding synchronous foil transfer process and the temperature of the molding surface (cavity forming surface) is higher than that of a molding surface in the typical injection-molding synchronous foil transfer process. For example, the temperature of the molten resin and the temperature of the molding surface are set around 280° C. to 340° C. and around 80° C. to 140° C., respectively, which are higher than those of the molten resin and the molding surface each set in the typical injection-molding synchronous foil transfer process. FIG. 10B is a partial enlarged cross-sectional view of the molded article 95. FIG. 10B is an enlarged view of a part B of FIG. 10A.

As shown in FIG. 10A, the transfer layer 93b is applied to the outer surface of the molded article 95. The transfer layer 93b includes the hard coating layer 83, the anchor layer 84, the color layer 85, the masking layer 86, and the adhesive layer 87. As shown in FIG. 8B, the transfer layer 93b originally needs to be peeled off from the base layer 93a at the boundary between the release layer 82 and the hard coating layer 83. However, under the molding conditions where the temperature of molten resin is higher than that of molten resin injected in the typical injection-molding synchronous foil transfer process and the temperature of the molding surface (cavity forming surface) is higher than that of a molding surface set in the typical injection-molding synchronous foil transfer process, as shown in FIG. 10B, the conventional injection-molding synchronous foil transfer process may partially peel off the transfer layer 93b bonded to the molded article 95. Specifically, as shown in FIG. 10B, peeling may occur in or between the layers where it should not occur, for example, between the hard coating layer 83 and the anchor layer 84 or between the color layer 85 and the masking layer 86. This is because the temperature of molten resin injected into the cavity of the injection mold and the temperature of the molding surface (cavity forming surface) are higher than those of molten resin and a molding surface each set in the typical injection-molding synchronous foil transfer process and thus a temperature in the exposure of the multilayer film 93 during molding and the opening of the mold is higher than that in the typical injection-molding synchronous foil transfer process, leading to peeling of the transfer layer 93b at a higher temperature than in the typical injection-molding synchronous foil transfer process. In other words, to obtain a predetermined peeling function, the release layer 82 needs to have a predetermined temperature. The peel strength (peeling resistance) of the release layer 82 increases with the temperature of the release layer 82. Thus, the peel strength of the release layer 82 increases with an ambient temperature. This causes the peel strength of the release layer 82 to be higher than that in the typical injection-molding synchronous foil transfer process when the transfer layer 93b is peeled off at a higher temperature than that in the typical injection-molding synchronous foil transfer process. Consequently, peeling may occur in or between some of the layers constituting the transfer layer 93b.

Thus, before the injection mold is opened after the completion of injection molding, the mold surface temperature needs to be reduced from a temperature for obtaining the flowability of engineering plastics to a temperature for obtaining the predetermined peeling function of the release layer 82. However, the mold surface of the conventional mold assembly requires a long cooling time. For example, in the mold assembly in FIG. 7, the cooling circuit 73 cannot be located near the molding surface 75. Thus, it takes a long time to reduce the temperature of the molding surface 75 to the temperature for obtaining the predetermined peeling function of the release layer in the mold assembly in FIG. 7. Hence, the mold assembly in FIG. 7 cannot shorten a molding cycle.

In the mold assembly in FIG. 6, the heating/cooling circuit 65 is located near the molding surface 64 but a heating medium passing through the heating/cooling circuit 65 is steam. Steam cannot increase the temperature of the molding surface 64 to the temperature for obtaining the flowability of molten engineering plastics. Thus, the mold assembly in FIG. 6 cannot be used for injection molding using engineering plastics. Furthermore, the mold assembly in FIG. 6 requires the typical cooling circuit 62 in addition to the heating/cooling circuit 65. In other words, the mold assembly in FIG. 6 cannot sufficiently cool the molding surface 64 only by means of the heating/cooling circuit 65 located near the molding surface 64.

In the typical injection-molding synchronous foil transfer process, the transfer layer 93b is peeled off substantially at the same time over the transfer surface of the molded article 95. Hence, when the transfer layer 93b is peeled off from the base layer 93a, a strong force is applied to the transfer layer 93b and causes a stress to an inner layer of the transfer layer 93b. This may cause peeling in or between some of the layers constituting the transfer layer 93b.

An object of the present invention is to provide an injection molding method that can achieve stable peeling and an injection mold assembly for realizing the injection molding method in an injection-molding synchronous foil transfer process in which the transfer layer of a multilayer film is transferred onto the surface (transfer surface) of a molded article while the molded article is obtained by injection molding.

An aspect of an injection molding method according to the present invention is an injection molding method in which a multilayer film including a base layer and a transfer layer stacked on the base layer is disposed in the molding space of an injection mold, the molding space containing the multiplayer film is filled with resin, and then the injection mold is opened to obtain a molded article transferred with the transfer layer peeled from the base layer, the method including the steps of: feeding the multilayer film into the opened injection mold; forming the molding space by closing the injection mold; injecting the resin into the molding space; cooling the multilayer film by a cooling circuit provided near the molding space; and opening the injection mold to obtain a molded article transferred with the transfer layer peeled off from the base layer.

Another aspect of the injection molding method according to the present invention, wherein the molding space includes a cavity forming surface having a flat surface and an outer part surrounding the flat surface, the outer part including a plurality straight lines and corners connecting the straight lines, and a temperature of the cooling circuit near the corners is lower than temperatures of the cooling circuit at other positions in the step of cooling the multilayer film by the cooling circuit.

Still another aspect of the injection molding method according to the present invention, wherein the corner has a radius of curvature.

Still another aspect of the injection molding method according to the present invention, wherein in the step of cooling the multilayer film by the cooling circuit, a temperature of the cooling circuit near the divided face of the injection mold is lower than temperatures of the cooling circuit at other positions.

Still another aspect of the injection molding method according to the present invention, wherein in the step of cooling the multilayer film by the cooling circuit, a temperature of the cooling circuit opposed to the opening end face of a gate portion is lower than temperatures of the cooling circuit at other positions, the gate portion being provided for injecting resin into the molding space.

An aspect of an injection mold assembly according to the present invention in which resin is injected from a gate portion into the molding space of an injection mold containing a multilayer film including a base layer and a transfer layer stacked on the base layer, and then the injection mold is opened to obtain a molded article transferred with the transfer layer peeled off from the base layer, the injection mold assembly including: a heating circuit located near the molding space; and a cooling circuit located closer to the molding space than the heating circuit, wherein after the resin is injected into the molding space, the cooling circuit cools the multilayer film before the injection mold is opened.

Another aspect of the injection mold assembly according to the present invention, wherein the molding space includes a cavity forming surface having a flat surface and an outer part surrounding the flat surface, the outer part including a plurality straight lines and corners connecting the straight lines, and a temperature of the cooling circuit near the corners is lower than temperatures of the cooling circuit at other positions.

Still another aspect of the injection mold assembly according to the present invention, wherein the corner has a radius of curvature.

Still another aspect of the injection mold assembly according to the present invention, wherein a temperature of the cooling circuit near the divided face of the injection mold is lower than temperatures of the cooling circuit at other positions.

Still another aspect of the injection mold assembly according to the present invention, wherein a temperature of the cooling circuit opposed to the opening end face of the gate portion facing the molding space is lower than temperatures of the cooling circuit at other positions.

According to the present invention, the transfer layer is easily peeled off from the base layer between desired layers even under molding conditions where the temperature of molten resin injected into the molding space of the injection mold is higher than that of molten resin injected in a typical injection-molding synchronous foil transfer process and the temperature of the cavity forming surface constituting the molding space is higher than that of a cavity forming surface set in the typical injection-molding synchronous foil transfer process. This reduces the deterioration of printed designs such as colors and patterns on the transfer layer, achieving a molded article with less deteriorated designs such as colors and patterns. Even under such molding conditions, sufficient bonding strength can be obtained between the molded article and the transfer layer on the molded article. Therefore, the present invention can achieve an injection-molding synchronous foil transfer process using high-value-added engineering plastics having characteristics such as high strength.

### BRIEF DESCRIPTION OF THE DRAWINGS

FIG. 1 is a side cross-sectional view illustrating the main part of a structural example of an injection mold assembly according to a first embodiment;

FIG. 2A is a side cross-sectional view illustrating an opened state of the injection mold assembly according to the first embodiment;

FIG. 2B is a partial enlarged side cross-sectional view illustrating a base layer on a dented cavity forming surface when the injection mold assembly is opened according to the first embodiment;

FIG. 2C is a partial enlarged side cross-sectional view illustrating a transfer layer on the surface of a molded article when the injection mold assembly is opened according to the first embodiment;

FIG. 3 is a flowchart showing an example of an injection molding method according to the first embodiment;

FIG. 4 is a plan view schematically showing a structural example of a dented cavity forming surface according to a second embodiment;

FIG. 5 is a side cross-sectional view illustrating the main part of a structural example of an injection mold assembly according to a third embodiment;

FIG. 6 is a cross-sectional view illustrating the main part of a mold for synthetic resin molding according to a conventional vapor medium system;

FIG. 7 is a cross-sectional view illustrating the main part of a mold for synthetic resin molding according to a conventional electric heater system;

FIG. 8A illustrates an example of the layer configuration of a typical multilayer film;

FIG. 8B illustrates an example of the typical layer configuration of a transfer layer and a base layer when the transfer layer peeled off from the base layer is transferred to the surface of a resin molding;

FIG. 9 is a side cross-sectional view illustrating an opened state of a conventional injection mold assembly;

FIG. 10A is a side cross-sectional view illustrating a molded article obtained by a conventional injection-molding foil transfer process; and

FIG. 10B is a partial enlarged side cross-sectional view illustrating the molded article obtained by the conventional injection-molding foil transfer process.

### DESCRIPTION OF THE EMBODIMENTS

Embodiments of the present invention will be described below with reference to the accompanying drawings. The same constituent elements are indicated by the same reference numerals and the explanation thereof is omitted. The constituent elements are schematically illustrated in the drawings for understanding. Moreover, the illustrated constituent elements are different from actual ones in shape, thickness, length, and number for the creation of the drawings. The materials, shapes, and dimensions of the constituent elements in the following embodiments are merely exemplary and are not particularly limited. Hence, the constituent elements can be changed in various ways without substantially departing from the effect of the present invention.

### First Embodiment

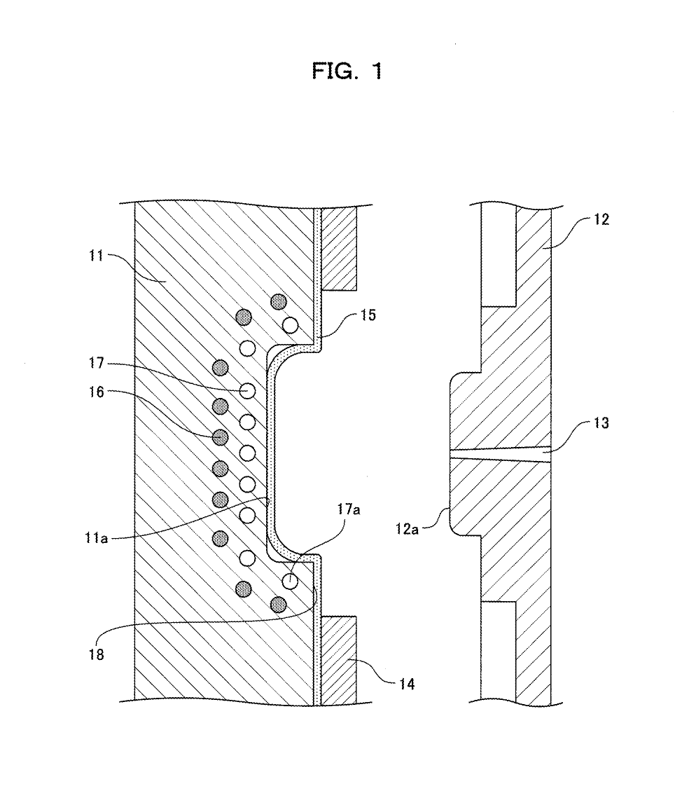

FIG. 1 is a side cross-sectional view illustrating the main part of a structural example of an injection mold assembly according to a first embodiment. The injection mold assembly performs an injection-molding synchronous foil transfer process. Specifically, in the injection mold assembly, molten resin (engineering plastics) is injected into the molding space (cavity) of an injection mold to obtain a molded article while the transfer layer of a multilayer film disposed in the cavity is transferred onto the surface (transfer surface) of the molded article. The injection mold assembly will be specifically described below.

As shown in FIG. 1, the injection mold assembly includes a movable mold 11 that is an example of a first mold and a fixed mold 12 that is an example of a second mold. An injection mold is generally made of steel.

The movable mold 11 has a dented cavity forming surface 11a that is an example of a first cavity forming surface. In the first embodiment, the dented cavity forming surface 11a has a bottom and a ring-shaped side. The bottom includes a flat surface and an outer part surrounding the flat surface. The outer part of the bottom is a curved part (curved surface) with a radius of curvature and connects the bottom to the side. The side of the dented cavity forming surface 11a surrounds the bottom so as to form a recess with the bottom. The side is orthogonal to the flat surface of the bottom.

The fixed mold 12 has a convex cavity forming surface 12a that is an example of a second cavity forming surface. The convex cavity forming surface 12a is provided for the dented cavity forming surface 11a of the movable mold 11. The convex cavity forming surface 12a forms a cavity with the dented cavity forming surface 11a when the movable mold 11 and the fixed mold 12 are closed by a mold driving device (not shown). In the first embodiment, the convex cavity forming surface 12a has a top surface and a ring-shaped side. The top surface includes a flat surface and an outer part surrounding the flat surface. The outer part of the top surface is a curved part (curved surface) with a radius of curvature and connects the top surface to the side. The side of the convex cavity forming surface 12a surrounds the top surface and forms a projecting portion with the top surface. Moreover, the side is orthogonal to the flat surface of the top surface.

The injection mold of the first embodiment further includes a gate portion 13 formed on the fixed mold 12. Molten resin is injected into the cavity from the gate portion 13. In the first embodiment, the gate portion 13 has an opening end (end face) at the center of the top surface of the convex cavity forming surface 12a.

The injection mold of the first embodiment includes a ring-shaped foil holding plate 14. When a multilayer film 15 is fed between the movable mold 11 and the fixed mold 12 by a foil feeder (not shown), the ring-shaped foil holding plate 14 moves to the movable mold 11 to hold the multilayer film 15 on an injection mold divided face 18 formed on the movable mold 11. Thus, the multilayer film 15 is held around the dented cavity forming surface 11a of the movable mold 11.

When the multilayer film 15 is held by the foil holding plate 14 in the injection mold assembly of the first embodiment, the multilayer film 15 is sucked from a vacuum suction hole (not shown) opened on the dented cavity forming surface 11a of the movable mold 11 and then is stretched along the dented cavity forming surface 11a. However, the multilayer film 15 cannot be completely stretched along the dented cavity forming surface 11a only by vacuum suction, causing a gap between the outer part (curved part) of the bottom of the dented cavity forming surface 11a and the multilayer film 15.

The injection mold of the first embodiment includes a heating circuit 16 and a cooling circuit 17 in the movable mold 11. The heating circuit 16 is disposed near the dented cavity forming surface 11a while the cooling circuit 17 is disposed closer to the dented cavity forming surface 11a than the heating circuit 16 is.

The heating circuit 16 heats the dented cavity forming surface 11a such that the temperature of the dented cavity forming surface 11a (molding surface temperature) is equal to or higher than the glass transition temperature of molded resin injected into the cavity. The molding surface temperature is preferable to be set about 10° C. higher than the glass transition temperature. This ensures the flowability of the molten resin injected into the cavity. An electric heater acts as the heating circuit 16 to set the temperature of the dented cavity forming surface 11a at the glass transition temperature of engineering plastics or higher. For example, the electric heater having a diameter of about 6 mm may be disposed with a central axis separated from the dented cavity forming surface 11a by about 5 mm. In this case, the adjacent central axes of the respective parts of the electric heater are spaced at about 20 mm.

After the molten resin is fully injected into the cavity, the cooling circuit 17 reduces the molding surface temperature to allow a release layer contained in the multilayer film 15 to sufficiently perform a peeling function. Thus, a transfer layer contained in the multilayer film 15 is stably applied to the surface of the molded article. For example, in the case where cooling water is passed through the cooling circuit 17, the cooling circuit (water passage) 17 having a diameter of about 10 mm may be located with a distance of about 5 mm from the central axis of the electric heater (heating circuit 16) to the central axis of the cooling circuit (water passage) 17, and then cooling water at about 20° C. may be passed through the cooling circuit (water passage) 17. In the case where a distance from the dented cavity forming surface 11a to the central axis of the electric heater (heating circuit 16) is about 5 mm, the cooling circuit 17 is diagonally arranged from the heating circuit 16 to the dented cavity forming surface 11a.

Furthermore, in the injection mold assembly of the first embodiment, when the molding surface temperature is reduced to allow the release layer contained in the multilayer film 15 to sufficiently perform the peeling function, the temperature of a part 17a of the cooling circuit 17 near the injection mold divided face 18 formed on the movable mold 11 is reduced by at least about 10° C. from the temperatures of other parts of the cooling circuit 17 located at other positions. For example, cooling water may be injected from the vicinity of the divided face 18 into the cooling circuit 17 spirally extended from the vicinity of the divided face 18 to the center of the dented cavity forming surface 11a. Alternatively, a cooling circuit 17a near the divided face 18 may be provided separately from the cooling circuit 17 located at the other position.

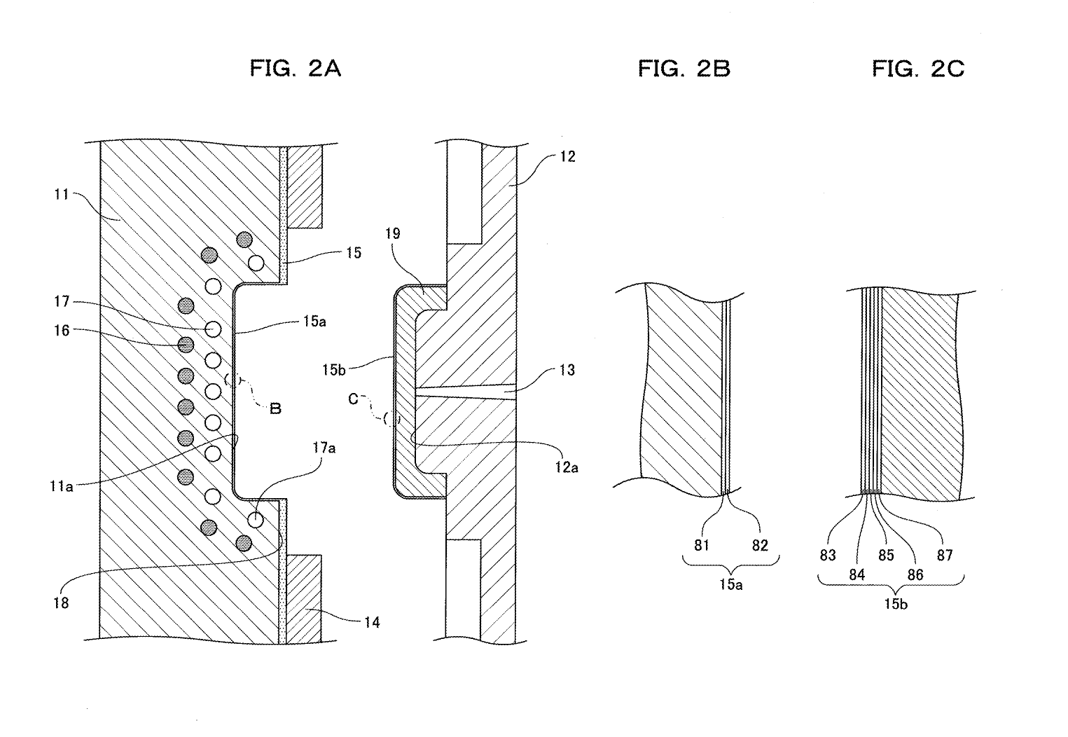

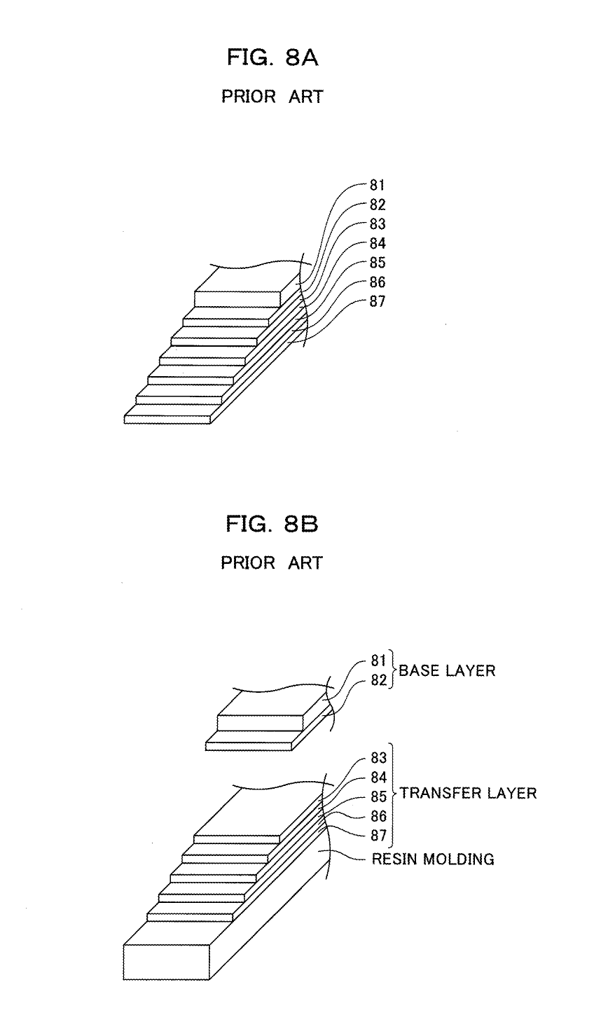

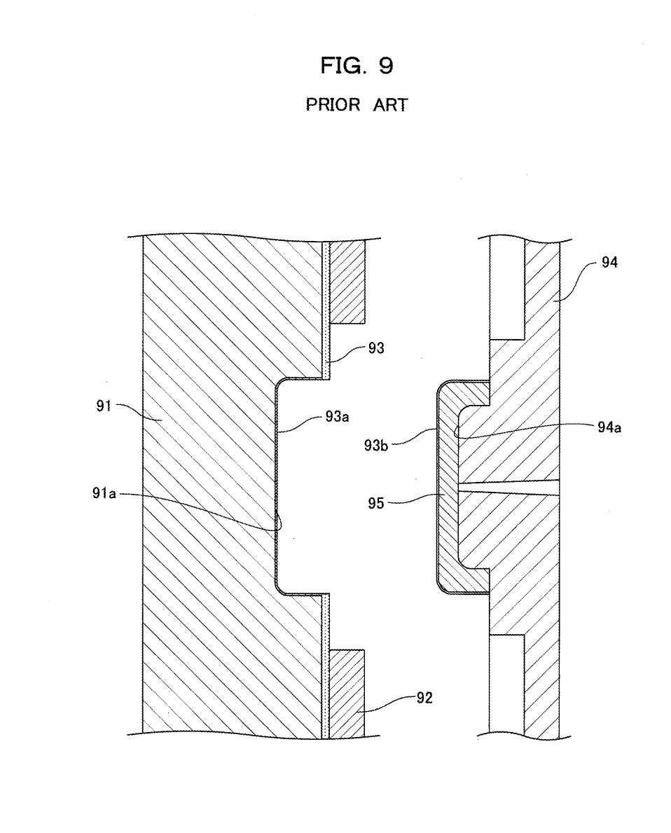

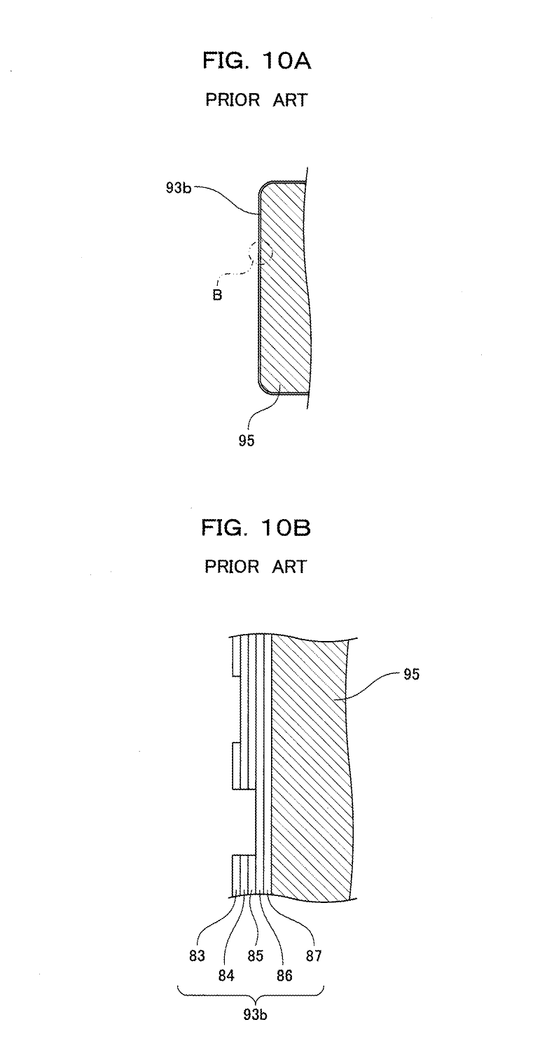

FIG. 2A is a side cross-sectional view illustrating an opened state of the injection mold assembly according to the first embodiment. FIG. 2B is a partial enlarged side cross-sectional view illustrating a base layer on the dented cavity forming surface when the injection mold assembly is opened according to the first embodiment. FIG. 2B is an enlarged view of part B of FIG. 2A. FIG. 2C is a partial enlarged side cross-sectional view illustrating the transfer layer on the surface of the molded article when the injection mold assembly is opened according to the first embodiment. FIG. 2C is an enlarged view of part C of FIG. 2A. In FIGS. 2A to 2C, the same constituent elements as in FIGS. 1 and 8 are indicated by the same reference numerals, and the explanation thereof is omitted.

In the first embodiment, the multilayer film 15 is the multilayer film illustrated in FIG. 8. Specifically, as shown in FIG. 8, the multilayer film 15 includes a base film 81, a release layer 82, a hard coating layer 83, an anchor layer 84, a color layer 85, a masking layer 86, and an adhesive layer 87 that are stacked in this order.

In the injection mold assembly according to the first embodiment, when the movable mold 11 and the fixed mold 12 are opened by the mold driving device (not shown) as shown in FIGS. 2A to 2C, a base layer 15a is peeled off from a transfer layer 15b at the boundary between the release layer 82 and the hard coating layer 83 over the dented cavity forming surface 11a of the movable mold 11. Thus, the base layer 15a is peeled off from a molded article 19 bonded to the convex cavity forming surface 12a of the fixed mold 12, transferring the transfer layer 15b onto the surface (transfer surface) of the molded article 19. This causes the base layer 15a peeled off from the transfer layer 15b to remain on the dented cavity forming surface 11a of the movable mold 11.

In a typical injection-molding synchronous foil transfer process, a transfer layer is peeled off from a base layer at the boundary between a release layer and a hard coating layer substantially at the same time over the dented cavity forming surface of a movable mold as when an injection mold is opened. However, unexpected peeling may occur under molding conditions where the temperature of molten resin injected into the cavity of the injection mold is higher than that of molten resin injected in the typical injection-molding synchronous foil transfer process and the temperature of the dented cavity forming surface is higher than that of a dented cavity forming surface set in the typical injection-molding synchronous foil transfer process. Specifically, the peel strength of the release layer is higher than that of the release layer in the typical injection-molding synchronous foil transfer process, causing peeling between layers other than the hard coating layer and the release layer or in some of layers constituting the transfer layer. For example, in the case where molten resin is engineering plastics, the temperature of the molten resin injected into the cavity is set at 280° C. to 340° C. while the temperature of the dented cavity forming surface is set at 80° C. to 140° C. so as not to interfere with the flowability of the molten resin injected into the cavity. Thus, the peel strength of the release layer is higher than that of the release layer in the typical injection-molding synchronous foil transfer process.

In the first embodiment, the cooling circuit 17 is disposed closest to the dented cavity forming surface 11a of the movable mold 11. Thus, the temperature of the multilayer film 15 disposed in the cavity can be reduced at least to a temperature where the release layer 82 can perform the predetermined peeling function, before the injection mold is opened after molten resin is fully injected into the cavity. This can shorten the cooling time of the multilayer film 15. Since the transfer layer 15b is likely to peel off from the base layer 15a at the boundary between the release layer 82 and the hard coating layer 83, the occurrence of unexpected peeling in or between the layers is reduced. This can achieve stable peeling.

Moreover, the temperature of the cooling circuit 17 near the injection mold divided face 18 formed on the movable mold 11 is lower than the temperatures of the cooling circuit 17 at other positions, allowing the multilayer film 15 in the cavity to have higher peeling capability near the divided face 18 than that at a location far from the divided face 18. Hence, when the injection mold is opened, the transfer layer 15b starts peeling off from the vicinity of the divided face 18 and then gradually peels toward the location far from the divided face 18. The temperature distribution of the multilayer film 15 is adjusted or controlled in the cavity, thereby reducing a stress applied to the inner layer of the transfer layer 15b when the injection mold is opened, as compared with peeling of the transfer layer substantially at the same time over the dented cavity forming surface in the conventional injection-molding synchronous foil transfer process. This can achieve more stable peeling.

With this configuration, the transfer layer 15b is stably peeled off from the base layer 15a at the boundary between the release layer 52 and the hard coating layer 53 even under the molding conditions where the temperature of molten resin injected into the cavity of the injection mold is higher than that of molten resin injected in the typical injection-molding synchronous foil transfer process and the temperature of the dented cavity forming surface 11a is higher than that of a dented cavity forming surface set in the typical injection-molding synchronous foil transfer process. Thus, printed designs such as colors and patterns are less deteriorated on the transfer layer 15b, achieving a molded article with less deteriorated designs such as colors and patterns.

The cooling circuit 17 may be provided in the fixed mold 12. The provision of the cooling circuit 17 in one of the movable mold 11 and the fixed mold 12 can achieve the foregoing effect. Alternatively, the movable mold 11 and the fixed mold 12 may each include the cooling circuit 17 to enhance the effect.

The foregoing configuration is also applicable to a slide core mold. The same effect as the first embodiment can be obtained in a slide core mold.

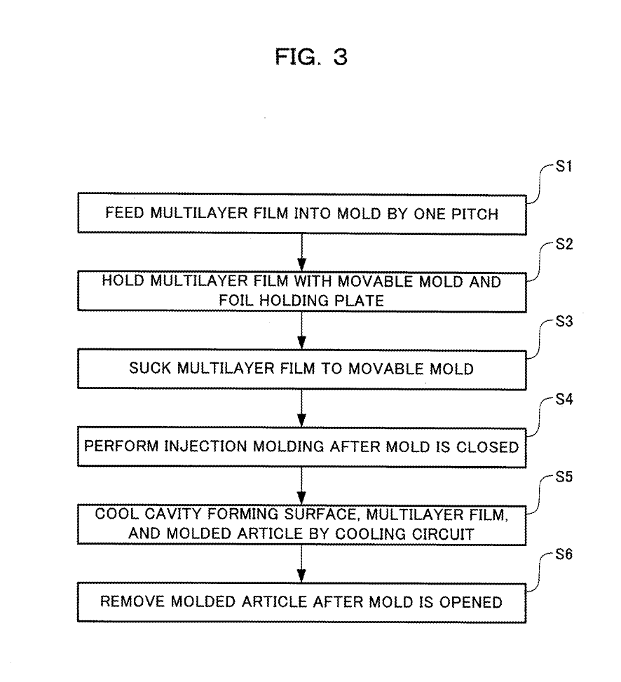

An injection molding method (injection-molding synchronous foil transfer process) using the injection mold assembly will be described below. FIG. 3 is a flowchart showing an example of the injection molding method (injection-molding synchronous foil transfer process) according to the first embodiment. In this example, cooling water is passed through the cooling circuit 17.

First, in step S1, the long multilayer film 15 including the base layer 15a and the transfer layer 15b stacked on the base layer 15a is fed into the mold by one pitch (desired distance). At this point, the multilayer film 15 is transported between the movable mold 11 and the fixed mold 12. The movable mold 11 at this point may be heated by the heating circuit 16. The timing for starting heating by the heating circuit 16 is set such that the temperature of the dented cavity forming surface 11a of the movable mold 11 reaches at least the glass transition temperature of molten resin (80° C. to 140° C. when molten resin is engineering plastics) before the molten resin is injected into the cavity. The timing for starting heating by the heating circuit 16 is determined in consideration of a time period for increasing the temperature of the dented cavity forming surface 11a of the movable mold 11 to a predetermined temperature.

Subsequently, in step S2, the ring-shaped foil holding plate 14 moves to the movable mold 11. Thus, the multilayer film 15 is held on the injection mold divided face 18 formed on the movable mold 11.

In step S3, the multilayer film 15 is then vacuum-sucked on the dented cavity forming surface 11a of the movable mold 11.

Subsequently, in step S4, the movable mold 11 and the fixed mold 12 are closed. This causes the dented cavity forming surface 11a of the movable mold 11 to form the cavity (molding space) in a molded article shape with the convex cavity forming surface 12a of the fixed mold 12. After that, molten resin is injected into the cavity, and then the cavity is filled with the molten resin. At this point, the multilayer film 15 is stretched by the injection pressure of the molten resin and comes into intimate contact with the dented cavity forming surface 11a of the movable mold 11.

From the start of injection of molten resin to the completion of the injection of the molten resin, the temperature of the dented cavity forming surface 11a of the movable mold 11 needs to be kept at the glass transition temperature of the molten resin or higher (about 10° C. higher than the glass transition temperature). Even if the heating circuit 16 stops the heating operation, the temperature of the dented cavity forming surface 11a of the movable mold 11 does not rapidly decrease. Thus, the heating operation of the heating circuit 16 is stopped before the molten resin is fully injected.

After the completion of the injection of the molten resin, in step S5, the cooling circuit 17 near the dented cavity forming surface 11a of the movable mold 11 cools the dented cavity forming surface 11a, the multilayer film 15, and the resin in the cavity at least to the solidification temperature of the resin in the cavity. This solidifies the resin in the cavity into the molded article 19. The cooling process is performed by passing cooling water through the cooling circuit 17. Thus, cooling water may be passed through the circuit after the molten resin is fully injected. Practically, the passage of cooling water is started in synchronization with the stop of the heating operation of the heating circuit 16.

Subsequently, in step S6, the movable mold 11 and the fixed mold 12 are opened. Thus, the base layer 15a of the multilayer film 15 is peeled off from the molded article 19 bonded to the convex cavity forming surface 12a of the fixed mold 12, transferring the transfer layer 15b of the multilayer film 15 onto the surface (transfer surface) of the molded article 19. After that, the molded article (injection molded article) 19 transferred with the transfer layer 15b is removed from the injection mold.

Cooling water is passed through the cooling circuit 17 until the molded article 19 is released from the convex cavity forming surface 12a. Practically, cooling water is passed through the cooling circuit 17 until the mold reaches a cooling setting temperature or until the heating operation of the heating circuit 16 is started. Air purge for discharging cooling water with air may be performed immediately before the start of the heating operation of the heating circuit 16 or immediately before the passage of cooling water through the cooling circuit 17.

Also in the case where the fixed mold 12 is provided with a cooling circuit, the cooling circuit is disposed near the convex cavity forming surface 12a of the fixed mold 12 like the cooling circuit 17 provided in the movable mold 11. Moreover, the temperature of the cooling circuit near an injection mold divided face formed on the fixed mold 12 is preferably set lower than the temperatures of the cooling circuit at other positions.

### Second Embodiment

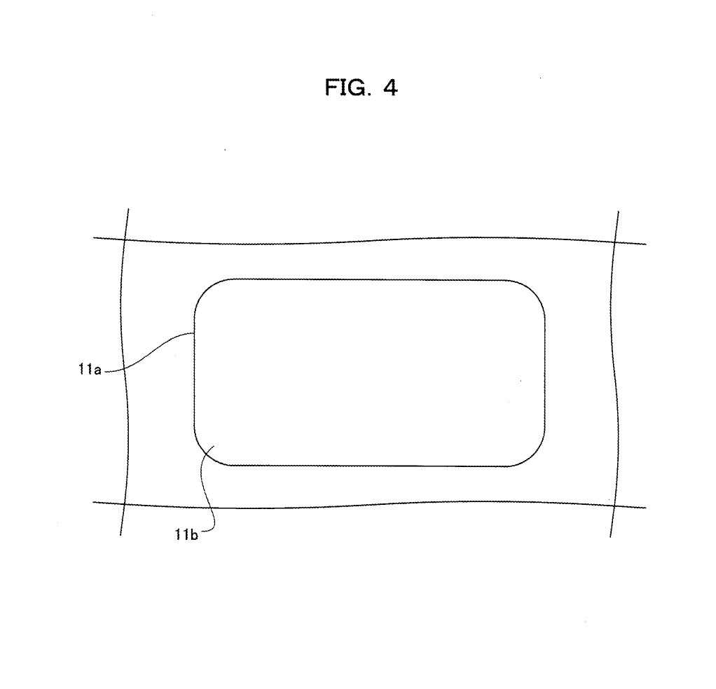

Referring to FIG. 4, constituent elements different from those described in the first embodiment will be mainly described below according to a second embodiment. FIG. 4 is a plan view schematically showing a structural example of a dented cavity forming surface 11a of a movable mold 11 according to the second embodiment. Parts not illustrated in FIG. 4 are identical to those of the first embodiment and thus the explanation thereof is omitted.

In the second embodiment, as shown in FIG. 4, the dented cavity forming surface 11a of the movable mold 11 has a rectangular bottom. The bottom has four corners 11b that are curved parts (curved surfaces) with a radius of curvature. Thus, a rounded side connected to the bottom has four straight lines and four corners connecting the four straight lines in plan view. The four corners are the curved parts (curved surfaces).

In the first embodiment, the temperature of the cooling circuit 17 near the injection mold divided face 18 formed on the movable mold 11 is lower than the temperatures of the cooling circuit 17 at other positions, whereas in the second embodiment, the temperature of a cooling circuit 17 near the four corners 11b of the bottom of the dented cavity forming surface 11a in FIG. 4 is reduced by at least about 10° C. from the temperatures of the cooling circuit 17 at other positions. In other words, the cooling circuit 17 has the lowest temperature near the four corners of the bottom of the dented cavity forming surface 11a. For example, cooling water may be injected from the vicinity of one of the four corners 11b into the cooling circuit 17 extended like a spiral to the center of the dented cavity forming surface 11a from the vicinity of the four corners 11b. Alternatively, a cooling circuit near the four corners 11b may be separately provided from the cooling circuit 17 located at the other position.

The cooling circuit 17 may cause cooling water injected from the vicinity of one of the four corners 11b to pass near the four corners 11b and then pass near a divided face 18. Thus, the temperature of the cooling circuit 17 near the four corners 11b of the dented cavity forming surface 11a is the lowest temperature while the temperature of the cooling circuit 17 near the divided face 18 is the second lowest temperature. Alternatively, a cooling circuit near the four corners 11b may be provided separately from the cooling circuit 17 at the other position, and cooling water may be injected from the vicinity of the divided face 18 into the cooling circuit 17 at the other position. Alternatively, a cooling circuit near the four corners 11b and a cooling circuit near the divided face 18 may be provided separately from the cooling circuit 17 at the other position.

The temperature of the cooling circuit 17 near the four corners 11b of the bottom of the dented cavity forming surface 11a is lower than that at other positions, allowing a transfer layer 15b to start peeling off from the four corners 11b when the injection mold is opened. Then, the transfer layer 15b continues to peel off from the four corners 11b toward the center of the bottom of the dented cavity forming surface 11a.

A multilayer film 15 in injection molding is locally reduced in thickness particularly on the four corners 11b of the bottom of the dented cavity forming surface 11a. Thus, the multilayer film 15 is likely to break on the four corners 11b of the bottom of the dented cavity forming surface 11a. Moreover, adhesion between layers constituting the transfer layer 15b may deteriorate on the corners 11b where the multilayer film 15 is reduced in thickness. Hence, peeling is likely to occur between some of the layers constituting the transfer layer 15b on the corners 11b. Furthermore, the corners 11b of the bottom of the dented cavity forming surface 11a each have a three-dimensional curvature that causes wrinkles on the multilayer film 15 when a base layer 15a of the multilayer film 15 peels off on the corners 11b. Thus, on the corners 11b, peeling resistance increases on the interface between the base layer 15a and the transfer layer 15b. This increases the possibility of peeling between some of the layers constituting the transfer layer 15b. In the second embodiment, the transfer layer 15b continues to peel off from the base layer 15a in directions from the four corners 11b of the bottom of the dented cavity forming surface 11a to the center of the bottom of the dented cavity forming surface 11a. Thus, as compared with the conventional injection-molding synchronous foil transfer process of peeling off the transfer layer substantially at the same time from the overall cavity forming surface, the inner layer of the transfer layer 15b receives a smaller stress on the four corners 11b of the bottom of the dented cavity forming surface 11a when the transfer layer 15b peels off from the base layer 15a on the four corners 11b. This can achieve stable peeling.

According to the second embodiment, the transfer layer 15b is more stably peeled off from the base layer 15a at the boundary between a release layer 52 and a hard coating layer 53 even under conditions where the temperature of molten resin injected into the cavity of the injection mold is higher than that of molten resin injected in a typical injection-molding synchronous foil transfer process and the temperature of the dented cavity forming surface 11a is higher than a mold surface temperature set in the typical injection-molding synchronous foil transfer process. For example, in the case of engineering plastics, the temperature of molten resin is 280° C. to 340° C., and the temperature of the dented cavity forming surface 11a is 80° C. to 140° C. This further reduces the deterioration of transferred designs such as colors and patterns on the surface (transfer surface) of a molded article.

Also in the case of a fixed mold 12 including the cooling circuit, the temperature of the cooling circuit near the most stretched part of the multilayer film 15 in injection molding is set lower than the temperatures of the cooling circuit at other positions, like the cooling circuit 17 provided in the movable mold 11. For example, in the case where a convex cavity forming surface 12a of the fixed mold 12 is an analog of the dented cavity forming surface 11a of the movable mold 11 illustrated in FIG. 4, the temperature of the cooling circuit near the four corners of the top surface of the convex cavity forming surface 12a of the fixed mold 12 is preferably set lower than the temperatures of the cooling circuit at other positions.

### Third Embodiment

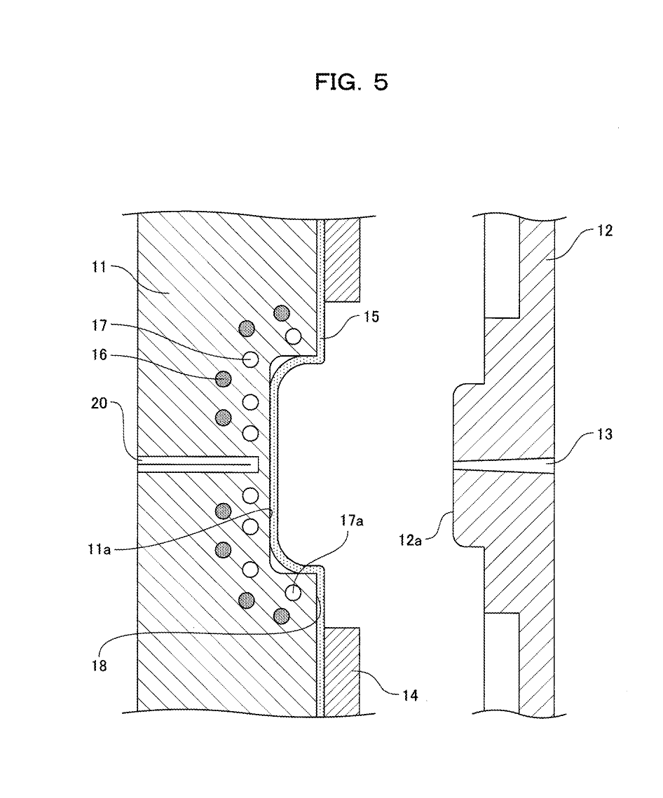

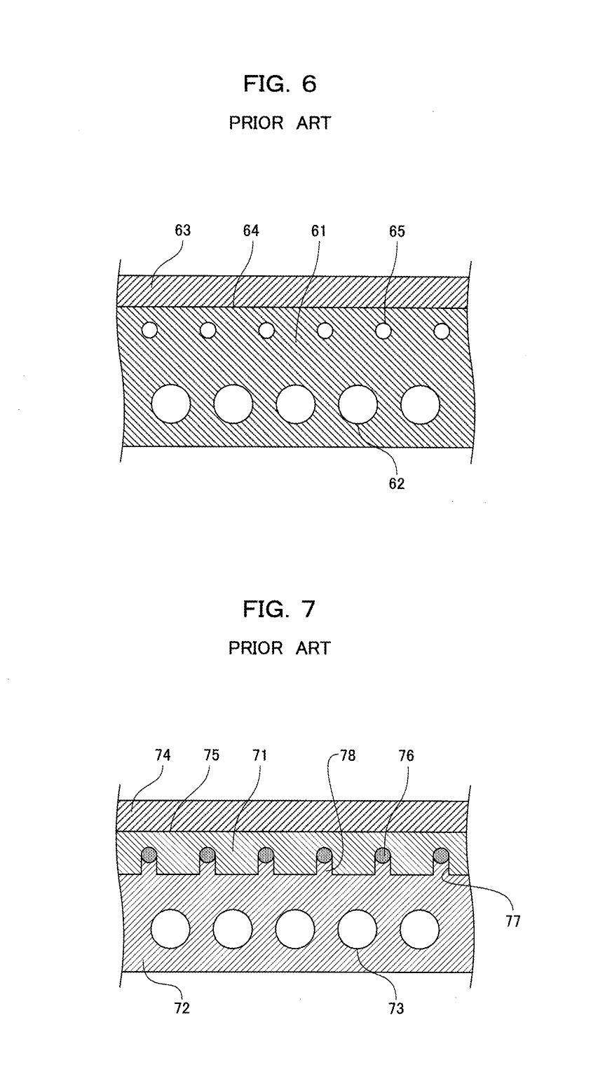

Referring to FIG. 5, constituent elements different from those described in the first embodiment will be mainly described below according to a third embodiment. FIG. 5 is a side cross-sectional view illustrating the main part of a structural example of an injection mold assembly according to the third embodiment. In FIG. 5, the same constituent elements as in FIG. 1 are indicated by the same reference numerals, and the explanation thereof is omitted.

In the injection mold assembly of the third embodiment, as shown in FIG. 5, a movable mold 11 includes a cooling circuit 20 that is different from the cooling circuit 17 of the first embodiment. The cooling circuit 20 is opposed to the opening end face of a gate portion 13 of a fixed mold 12. For example, in the case where cooling water is passed through the cooling circuit 20, the cooling circuit (water passage) 20 may have a diameter of about 10 mm.

On a dented cavity forming surface 11a of the movable mold 11, molten resin in injection molding swiftly flows to a point opposed to the opening end face of the gate portion 13. On the dented cavity forming surface 11a, the point opposed to the opening end face of the gate portion 13 has a highest temperature.

In the third embodiment, the cooling circuit 20 different from the cooling circuit of the first embodiment is provided near a region having the highest temperature. For example, the cooling circuit 20 is fed with cooling water having a lower temperature than cooling water passing through the cooling circuit 17 of the first embodiment, resulting in the better cooling function of the cooling circuit 20 than that of the cooling circuit 17 according to the first embodiment. This sufficiently reduces the peeling resistance (peel strength) of a multilayer film 15 so as to stably peel off a transfer layer 15b from a base layer 15a when the injection mold is opened.

According to the third embodiment, the transfer layer 15b is more stably peeled off from the base layer 15a at the boundary between a release layer 52 and a hard coating layer 53 even under conditions where the temperature of molten resin injected into the cavity of the injection mold is higher than that of molten resin injected in a typical injection-molding synchronous foil transfer process and the temperature of the dented cavity forming surface 11a is higher than that of a dented cavity forming surface set in the typical injection-molding synchronous foil transfer process. For example, in the case of engineering plastics, the temperature of molten resin is 280° C. to 340° C., and the temperature of the dented cavity forming surface 11a is 80° C. to 140° C. This further reduces the deterioration of transferred designs such as colors and patterns on the surface (transfer surface) of a molded article.

The configuration and method of the third embodiment are applicable to the injection mold assembly and the injection molding method of the second embodiment. For example, the cooling circuit 20 is provided separately from the cooling circuit of the second embodiment and is fed with cooling water having a lower temperature than cooling water passing through the cooling circuit of the second embodiment, resulting in the better cooling function of the cooling circuit 20 than that of the cooling circuit according to the second embodiment.

The injection molding methods and the injection mold assemblies according to the foregoing embodiments are useful for the injection molding of various external molded articles.

Having specifically described several exemplary embodiments of the present invention, it will be easily understood by those skilled in the art that various modifications can be made in the exemplary embodiments without substantially departing from a new teaching and the effect of the present invention. Therefore, such modifications are intended to fall within the scope of the present invention.

What is claimed is:

1. An injection molding method in which a multilayer film including a base layer and a transfer layer stacked on the base layer is disposed in a molding space of an injection mold, the molding space containing the multiplayer film is filled with resin, and then the injection mold is opened to obtain a molded article transferred with the transfer layer peeled from the base layer,
the method comprising the steps of:
feeding the multilayer film into the opened injection mold;
forming the molding space by closing the injection mold;
injecting the resin into the molding space;
cooling the multilayer film by a cooling circuit provided near the molding space; and
opening the injection mold to obtain a molded article transferred with the transfer layer peeled off from the base layer.

2. The injection molding method according to claim 1, wherein the molding space includes a cavity forming surface having a flat surface and an outer part surrounding the flat surface, the outer part including a plurality straight lines and corners connecting the straight lines, and
a temperature of the cooling circuit near the corners is lower than temperatures of the cooling circuit at other positions in the step of cooling the multilayer film by the cooling circuit.

3. The injection molding method according to claim 2, wherein the corner has a radius of curvature.

4. The injection molding method according to claim 1, wherein in the step of cooling the multilayer film by the cooling circuit, a temperature of the cooling circuit near a divided face of the injection mold is lower than temperatures of the cooling circuit at other positions.

5. The injection molding method according to claim 1, wherein in the step of cooling the multilayer film by the cooling circuit, a temperature of the cooling circuit opposed to an opening end face of a gate portion is lower than temperatures of the cooling circuit at other positions, the gate portion being provided for injecting resin into the molding space.

6. An injection mold assembly in which resin is injected from a gate portion into a molding space of an injection mold containing a multilayer film including a base layer and a transfer layer stacked on the base layer, and then the injection mold is opened to obtain a molded article transferred with the transfer layer peeled off from the base layer,
the injection mold assembly comprising:
a heating circuit located near the molding space; and
a cooling circuit located closer to the molding space than the heating circuit,
wherein after the resin is injected into the molding space, the cooling circuit cools the multilayer film before the injection mold is opened.

7. The injection mold assembly according to claim 6, wherein the molding space includes a cavity forming surface having a flat surface and an outer part surrounding the flat surface, the outer part including a plurality straight lines and corners connecting the straight lines, and
a temperature of the cooling circuit near the corners is lower than temperatures of the cooling circuit at other positions.

8. The injection mold assembly according to claim 7, wherein the corner has a radius of curvature.

9. The injection mold assembly according to claim 6, wherein a temperature of the cooling circuit near a divided face of the injection mold is lower than temperatures of the cooling circuit at other positions.

10. The injection mold assembly according to claim 6, wherein a temperature of the cooling circuit opposed to an opening end face of the gate portion facing the molding space is lower than temperatures of the cooling circuit at other positions.
